(19) United States
(12) Patent Application Publication
(10) Pub. No.: US 2020/0233653 A1
(43) Pub. Date: Jul. 23, 2020

(54) PROGRAM UPDATING METHOD

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-shi, Osaka (JP)

(72) Inventor: Hayato Fukushima, Yokkaichi, Mie (JP)

(21) Appl. No.: 16/486,292

(22) PCT Filed: Feb. 7, 2018
(86) PCT No.: PCT/JP2018/004164

§ 371 Date: Aug. 15, 2019

(30) Foreign Application Priority Data
Feb. 27, 2017 (JP) 2017-034991

(51) Int. Cl. G06F 8/65; G06F 9/445; G06F 9/54

(52) U.S. Cl. CPC G06F 8/65; G06F 9/542; G06F 9/445

(57) ABSTRACT

Provided is a technique for a user deciding a timing to update a program. A program that controls the operation of a device installed in a vehicle is updated. This method of updating includes a first step of determining whether or not storage of an update program for updating the program is complete, a second step of notifying that the storage is complete when a result of the determination in the first step is affirmative, and a third step of, after the second step, starting updating of the program by means of the stored update program after a predetermined instruction.

### CROSS-REFERENCE TO RELATED APPLICATIONS

This application is the U.S. national stage of PCT/JP2018/004164 filed on Feb. 7, 2018, which claims priority of Japanese Patent Application No. JP 2017-034991 filed on Feb. 27, 2017, the contents of which are incorporated herein.

### TECHNICAL FIELD

This disclosure relates to updating a program that controls the operation of a device that is installed in a vehicle.

### BACKGROUND

Electronic control units (hereinafter also referred to as ‘ECUs’; same in the drawings) are known as devices that are installed in vehicles (hereinafter also referred to as ‘in-vehicle devices’). These ECUs control the operation of the engine, for example. The operations of the ECUs are controlled by programs.

It is possible to update these programs (hereinafter also referred to as ‘updating’). There is a well known method in which a program (hereinafter ‘update program’) for updating these programs is downloaded from outside of the vehicle, and the downloaded update program is used to update the programs of the in-vehicle device. For example, JP 2004-326689A listed below introduces a technique in which the update program is downloaded from a service center to the vehicle via a mobile communication network, and the downloaded update program is used to update the programs of the in-vehicle devices.

However, with the technique disclosed in JP 2004-326689A, updating programs is to be performed directly, after the update program is downloaded, as long as the update program is not abnormal (for example, steps S13, S14, and S15 shown in FIG. 3 and paragraph 0028 of JP 2004-326689A).

In this way, cases are envisaged where processing in which downloading of the update program being directly connected to updating by the downloaded update program is inconvenient to the user of the vehicle. This is because there are cases where, even though downloading can be performed while a vehicle is traveling, it is not possible to operate the vehicle while updating is being performed. For example, it may not be possible to operate the engine of the vehicle while the program of the ECU that controls the engine is updating. Conversely, it is desirable that the program of the ECU that controls the engine is not updated while the engine is operating.

In view of this, an object of the present disclosure is to provide a technique in which the timing of updating a program is determined by a user.

### SUMMARY

A program updating method according to an aspect of the present disclosure is a method for updating a program that controls the operation of a device that is installed in a vehicle. The method includes a first step of determining whether or not storage of an update program for updating the program is complete, a second step of notifying that the storage is complete when a result of the determination in the first step is affirmative, and a third step of, after the second step, updating of the program starting by means of the stored update program after a predetermined instruction.

### Advantageous Effects of Disclosure

In the program updating method, even when storage of the update program is complete, updating by means of the stored update program is not performed automatically. After storage of the update program is complete, a user gives a predetermined instruction and program updating is then performed. Thus, the timing of this updating can be determined by the user.

### BRIEF DESCRIPTION OF DRAWINGS

FIG. 1 is a diagram showing a vehicle in which a program updating method according to a first embodiment is performed.

FIG. 2 is a flowchart showing the program updating method according to the first embodiment.

FIG. 3 is a diagram showing what is displayed by a car navigation system in the first embodiment.

FIG. 4 is a diagram showing what is displayed by the car navigation system in the first embodiment.

FIG. 5 is a diagram showing what is displayed by the car navigation system in the first embodiment.

FIG. 6 is a diagram showing a vehicle in which the program updating method according to a second embodiment is performed.

FIG. 7 is a flowchart showing the program updating method according to the second embodiment, with some parts omitted.

FIG. 8 is a diagram showing what is displayed by the car navigation system in the second embodiment.

FIG. 9 is a diagram showing what is displayed by the car navigation system in the second embodiment.

FIG. 10 is a diagram showing what is displayed by the car navigation system in the second embodiment.

FIG. 11 is a diagram showing the vehicle in which the program updating method according to a variation of the second embodiment is performed.

FIG. 12 is a flowchart showing the program updating method according to the variation of the second embodiment, with some parts omitted.

FIG. 13 is a diagram showing what is displayed by a speedometer in the variation of the second embodiment.

FIG. 14 is a diagram showing what is displayed by the speedometer in the variation of the second embodiment.

FIG. 15 is a diagram showing what is displayed by the speedometer in the variation of the second embodiment.

### DETAILED DESCRIPTION OF PREFERRED EMBODIMENTS

### First Embodiment

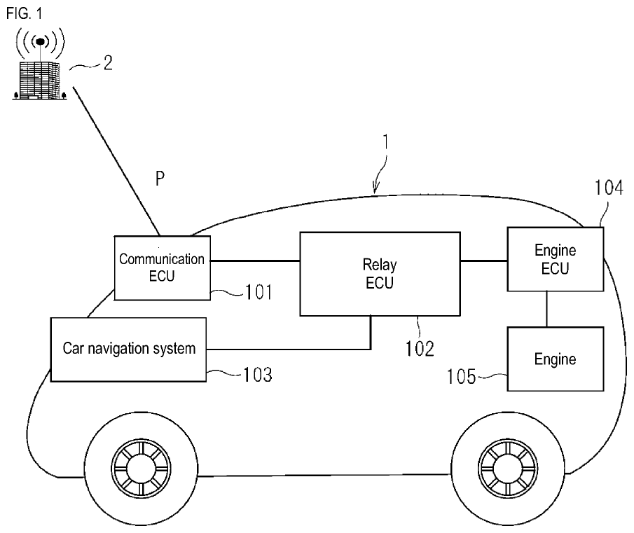

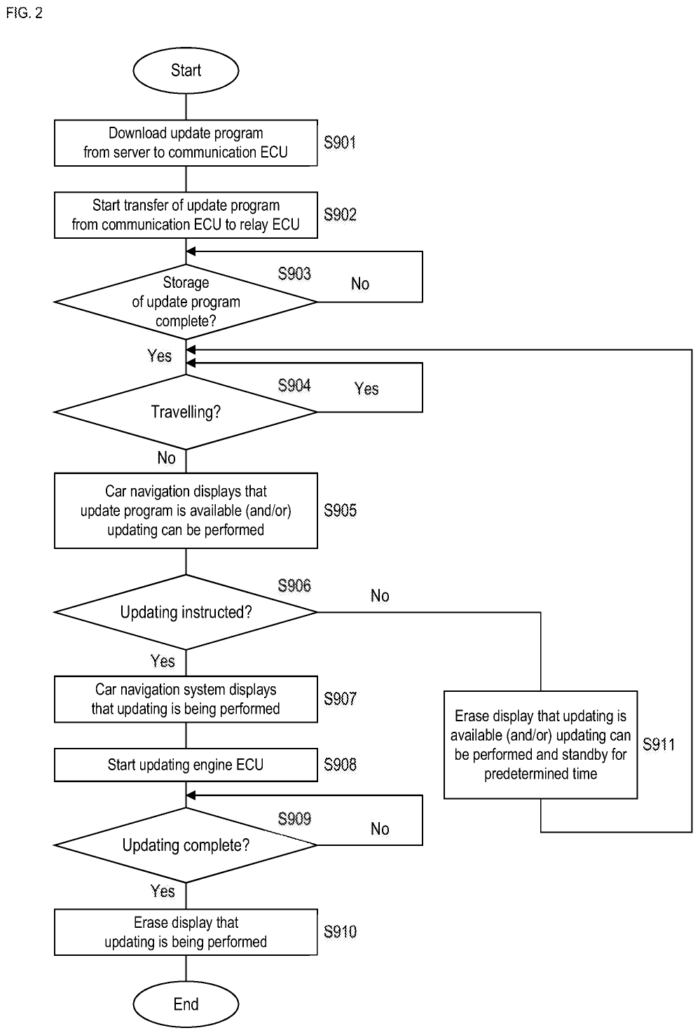

The following describes a program updating method according to a first embodiment. FIG. 1 is a diagram showing a vehicle 1 in which the updating method is performed. FIG. 2 is a flowchart showing the updating method.

A communication ECU 101, a relay ECU 102, a car navigation system 103, an engine ECU 104, and an engine 105 are installed in the vehicle 1. Needless to say, other constituent elements for performing other operations are also installed in the vehicle 1, however those other constituent elements have only a limited connection to the present embodiment and thus illustrations and descriptions thereof will be omitted.

The engine ECU 104 is an ECU for controlling the operation of the engine 105. The engine ECU 104 is an in-vehicle device that operates based on a program and is the subject of program updating in the present embodiment.

The communication ECU 101 receives an update program P from a server 2 by communicating therewith. Thus, the update program P is downloaded to the communication ECU 101 (step S901). This communication may be realized through wireless communication, for example. Although omitted from the drawings, this communication can be performed via a well known communication network.

Next, transfer of the update program P from the communication ECU 101 to the relay ECU 102 is started (step S902). Ethernet (registered trademark), for example, may be used as the method of transferring the update program P from the communication ECU 101 to the relay ECU 102, in which case high speed transfer is possible. A central gateway or an Ethernet switch, for example, may be used as the relay ECU 102.

Next, it is determined whether or not storage of the update program P is complete (step S903). This determination may be realized by, for example, the relay ECU 102 determining whether or not the transfer of the update program P thereto is complete. Alternatively, this determination may also be realized by the communication ECU 101 determining whether or not the transfer of the update program P is complete.

If the result of the determination in step S903 is negative (shown as “No” in FIG. 2; the same hereinafter), that is, as long as it is determined that storage of the update program P is not complete, the determination in step S903 is repeated.

If the result of the determination in step S903 is affirmative (shown as “Yes” in FIG. 2; the same hereinafter), updating of the program of the engine ECU 104 is ready to be performed by the relay ECU 102 with use of the update program P.

However, as already described, it is desirable that the program of the engine ECU 104 is not updated while the engine 105 is operating. Therefore, even if the result of the determination in step S903 is affirmative, updating will not be performed if the vehicle 1 is traveling and, as will be described later, the user will also not be notified that downloading is complete.

Specifically, if the result of the determination in step S903 is affirmative, processing proceeds to step S904. In step S904, it is determined whether or not the vehicle 1 is traveling. This determination can be performed by, for example, the relay ECU 102 based on the operational status of another ECU such as the engine ECU 104.

If the result of the determination in step S904 is affirmative, that is, as long as it is determined that the vehicle 1 is traveling, the determination in step S904 is repeated.

If the result of the determination in step S904 is negative, which is a state where the vehicle 1 is not traveling, processing proceeds to step S905. In step S905, the car navigation system 103 will display either one of, or both of, the update program P being available and updating being possible. This display can be executed by the car navigation system 103 with use of the control of the relay ECU 102. Even in a state where the vehicle 1 is not traveling, as is well known, it is possible to operate, for example, the communication ECU 101, the relay ECU 102, the car navigation system 103, and the engine ECU 104 with only a battery (not shown) that is typically provided in the vehicle 1.

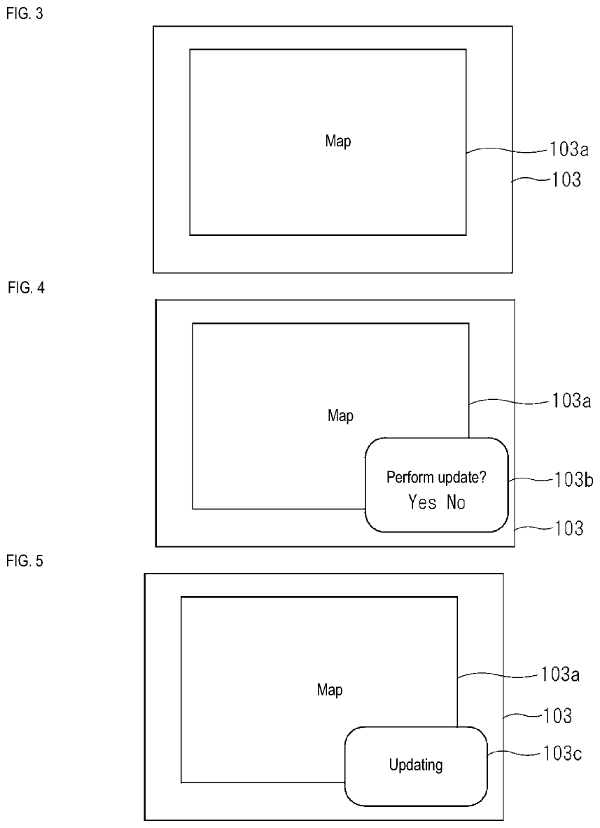

FIG. 3 and FIG. 4 are diagrams showing what is displayed by the car navigation system 103. FIG. 3 shows a state where only a function inherent to the car navigation system 103, such as the display of a map 103a, is displayed, and shows what is displayed by the car navigation system 103 before step S905 is executed.

FIG. 4 shows what is displayed by the car navigation system 103 when step S905 has been executed. In FIG. 4, as a display showing that updating is possible, a display 103b is performed for choosing whether or not updating is to be performed. This display, in the present embodiment, corresponds to displaying that updating is ready to be performed, and that the update program P is available.

After step S905 has been executed, processing proceeds to step S906 and it is determined whether or not updating has been instructed by a user. Unlike in the technique disclosed in JP 2004-326689A, updating in the present embodiment will not be performed without this instruction.

Touch-input on a screen of the car navigation system 103 can be used as a technique for realizing a user instruction as to whether or not to permit updating. In terms of FIG. 4, an update instruction is given by the user touching the vicinity of “Yes” in the display “Perform Update? Yes No” of the display 103b. Alternatively, the user can instruct to not permit updating by touching the vicinity of “No” of the display 103b.

If the result of the determination in step S906 is negative, which, in terms of FIG. 4, means that the vicinity of “No” from the display content 103b is touched, processing returns to step S904 through step S911. In step S911, the display performed in step S905, which, in terms of FIG. 4, is the display content 103b, is erased and a predetermined standby time is provided. Thus, the car navigation system 103 performs display as illustrated in FIG. 3. Step S911 is processing for causing the update to standby until updating is convenient for the user. The predetermined time can be, for example, one hour.

Note that after step S911 has been executed, processing may also return to step S905. However, given the reason for providing step S904, that is, from the viewpoint of avoiding updates while the vehicle is traveling, it is desirable that processing returns to step S904 after step S911 has been executed.

If the result of the determination made in step S906 is affirmative, which, in terms of FIG. 4, means that the vicinity of “Yes” of the display 103b is touched, processing proceeds to step S907, and the car navigation system 103 displays that updating is being performed (that a program is continuing to be updated).

FIG. 5 is a diagram showing what is displayed by the car navigation system 103 when step S907 has been executed. FIG. 5 illustrates a case where “updating” is displayed as a display 103c.

Processing then proceeds to step S908, and in step S908 the relay ECU 102 uses the update program P to start updating the program of the engine ECU 104.

Updating that was started in step S908 continues, and the display 103c continues to be displayed until it is determined that updating is complete. Specifically, in step S909, which is executed following step S908, it is determined whether or not updating is complete. This determination can be executed by the relay ECU 102 that uses the update program P to update the engine ECU 104.

As long as the result of the determination in step S909 is negative, step S909 will continue to be executed. If the result of this determination becomes affirmative, processing proceeds to step S910, and the display 103c is erased in step S910. Thus, the car navigation system 103 performs the display shown in FIG. 3.

Displaying either of the displays 103b or 103c is not a function that is inherent to the car navigation system 103. Accordingly, it is desirable that the displays 103b and 103c are displayed such that they do not hinder visibility of the map 103a, which is displayed as a function inherent to the car navigation system 103. In the examples illustrated in FIG. 4 and FIG. 5, the displays 103b and 103c are displayed in the vicinity of the lower right hand corner of the map 103a.

In this way, it is determined whether or not storage of the update program P is complete in step S903, and when the result of the determination in step S903 is affirmative, it is notified in step S905 that storage of the update program P is complete. After a predetermined instruction is given after step S905, which is an update instruction by a user in the foregoing example, in step S908, program updating by means of the stored update program P is started.

Accordingly, even when storage of the update program P is complete, updating by means of the stored update program P will not be performed automatically. The program will be updated when the user gives a predetermined instruction after the user is aware of the notification informing the user that storage is complete. Thus, the user can determine the timing of the updating.

Also, step S905 is executed after it is determined in step S904 that the vehicle 1 is not traveling, and thus it is possible to prevent the user from mistakenly starting a download.

It is notified in step S907 that the updating is ongoing. This is desirable from the viewpoint of preventing a user from mistakenly starting to operate an in-vehicle device (the engine ECU 104 that controls the engine 105, for example) while updating is being performed. Note that, even if the user attempts to operate the engine 105 while the program of the engine ECU 104 is being updated (updating), this attempt will fail.

It is notified in step S910 that updating is complete, and thus the user can be aware of the timing at which operation of an in-vehicle device can be started.

### Second Embodiment

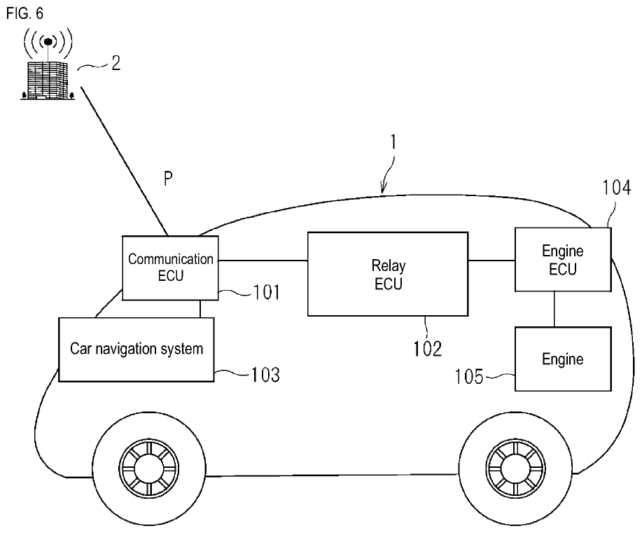

The following describes an updating method according to a second embodiment. FIG. 6 is a diagram showing the vehicle 1 in which the updating method is performed. Note that in the description of the present embodiment, constituent elements and steps that are similar to those in the first embodiment shall be denoted with the same reference numerals and descriptions thereof shall be omitted.

The communication ECU 101, in the present embodiment, receives the update program P from the server 2 by communicating therewith, similarly to the first embodiment. However, unlike in the first embodiment, the communication ECU 101, in the present embodiment, also controls the operation of the car navigation system 103.

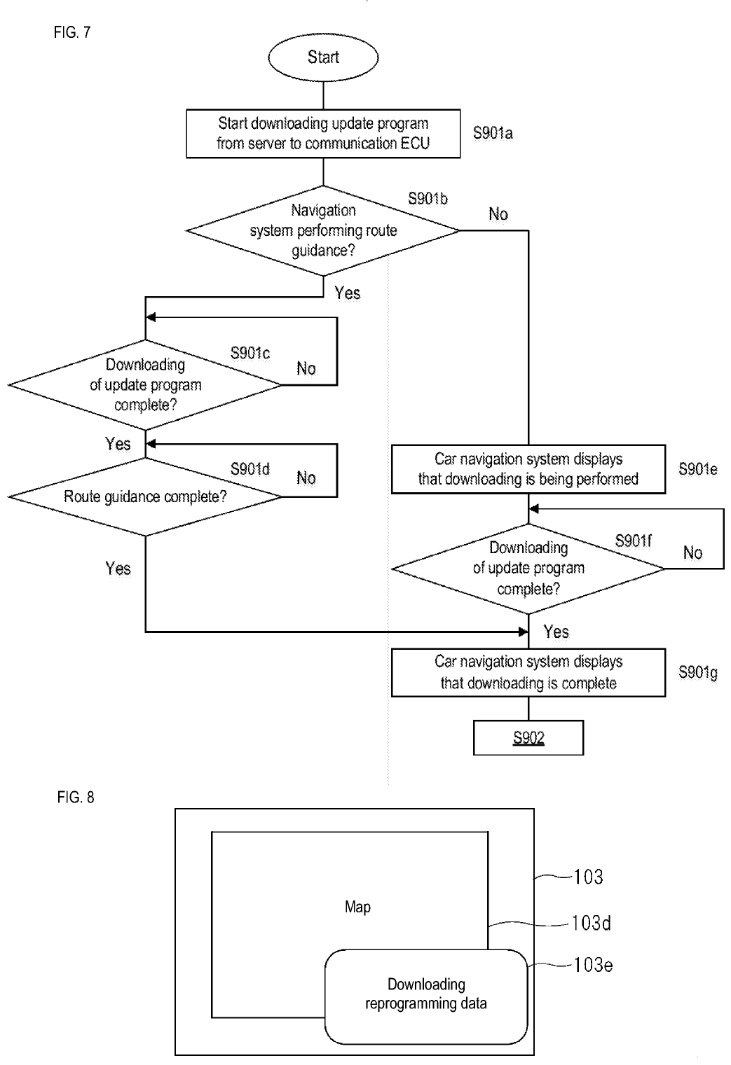

FIG. 7 is a flowchart showing the program updating method according to the present embodiment, with some parts omitted. In the present embodiment, step S901 in the flowchart shown in FIG. 2 in relation to the first embodiment is replaced with steps S901a to S901g shown in FIG. 7. Accordingly, illustration of steps S903 to S911 in the flowchart shown in FIG. 2 is omitted from the flowchart in FIG. 7.

With the present embodiment, first, in step S901a, downloading of the update program P from the server 2 to the communication ECU 101 is started. After downloading is started, it is determined in step S901b whether or not the car navigation system 103 is performing route guidance. If the result of the determination in step S901b is negative, information about the downloading is notified in the car navigation system 103. If the result of this determination is affirmative, information about the downloading is not notified so that visibility of the route guidance is not hindered.

Generally speaking, it could be said that the vehicle 1 includes a display apparatus, such as a car navigation system 103, for example, that has both a first function and a second function. Here, the first function is displaying predetermined information (for example, route guidance if the car navigation system 103 is used as an example of the display apparatus). Furthermore, the second function is notifying the downloading status of the update program P, such as completion thereof.

When the display apparatus is exhibiting the first function, the second function will activate after the first function stops, even if an affirmative result is obtained when determining whether or not updating of the program P is complete. On the other hand, when the display apparatus has stopped the first function (for example, in the case of simply displaying the map and not route guidance if the car navigation system 103 is used as an example of the display apparatus), the second function will activate after the result of this determination becomes affirmative. By using branched processing such as this, predetermined information is preferentially displayed over notification that the update program P has finished downloading.

The following describes an example of a specific process. If the result of the determination in step S901b is affirmative, processing proceeds to step S901c. In step S901c, it is determined whether or not updating of the update program P is complete.

With the present embodiment, the communication ECU 101 controls the car navigation system 103 and therefore this determination can be realized by the communication ECU 101 determining whether or not the transfer of the update program P is complete.

If the result of the determination made in S901c is affirmative, processing proceeds to step S901d, or step S901c is repeated if the result is negative.

In step S901d, it is determined whether or not route guidance in the car navigation system 103 is complete. With the present embodiment, the communication ECU 101 controls the car navigation system 103 and therefore this determination can be performed by the communication ECU 101.

If the result of the determination in step S901d is negative, step S901d is repeated to prioritize route guidance. If the result of the determination in step S901d is affirmative, processing proceeds to step S901g.

If the result of the determination in step S901b is negative, processing proceeds to step S901e. In step S901e, it is notified that downloading is being performed. Specifically, the car navigation system 103 displays that downloading is being performed.

FIG. 8 shows what is displayed by the car navigation system 103 when step S901e has been executed. A map 103d is a map that is shown in a state where route guidance is not being performed (that is, when the first function described above has been stopped). In contrast, whether or not the map 103a in the first embodiment (see FIGS. 3 to 5) is performing route guidance is irrelevant. A display 103e is display for notifying that downloading is being performed, and may display “Downloading reprogramming data”, for example. Here, “reprogramming data” refers to the update program P.

After step S901e has been executed, processing proceeds to step S901f. In step S901f, similarly to in step S901c, it is determined whether or not downloading of the update program P is complete.

Processing proceeds to step S901g if the result of the determination in S901f is affirmative, or step S901f is repeated if the result is negative. In step S901g, it is notified that downloading is complete (which corresponds to the second function described above). Specifically, the car navigation system 103 displays that downloading of the update program P is complete. After step S901g has been executed, processing proceeds to step S902.

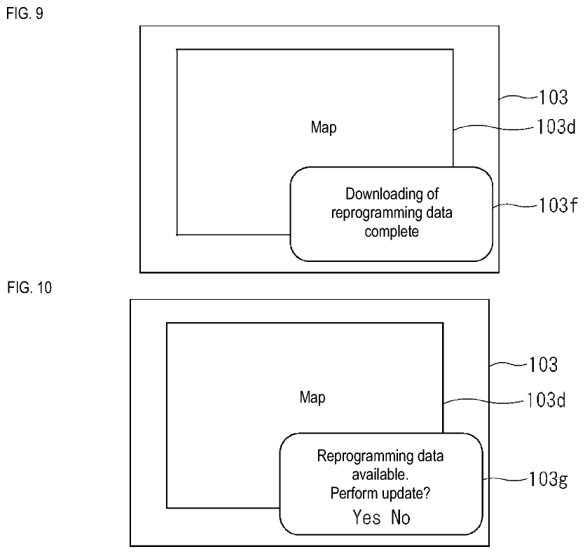

FIG. 9 shows what is displayed by the car navigation system 103 when step S901g has been executed. A display 103f is display for notifying that downloading is complete, and may display “Reprogramming data download complete”, for example.

Processing from step S902 onward is performed similarly to processing in the first embodiment. FIG. 10 shows what is displayed by the car navigation system 103 when step S905 (FIG. 2) has been executed in the present embodiment. FIG. 10 illustrates an example in which a display 103g showing both that the update program P is available and that updating is possible (shows a choice of whether or not to update) is displayed on the car navigation system 103.

Needless to say, similarly to the first embodiment, the display 103b (FIG. 4) may be used instead of the display 103g in the present embodiment. Conversely, the display 103g may be used instead of the display 103b in the first embodiment.

It is desirable that the displays 103e, 103f, 103g are, similarly to the displays 103b and 103c, displayed such that they do not hinder the visibility of the map 103a that is displayed as an inherent function of the car navigation system 103. In the examples illustrated in FIGS. 8 to 10, the displays 103e, 103f and 103g are displayed in the vicinity of the lower right hand corner of the map 103a.

### Variations

Variation of the first embodiment and the second embodiment:

It is desirable that step S907 is, in view of the reason for the display, provided directly before or directly after step S908. Accordingly, step S907 may also be provided directly before step S908 as illustrated in FIG. 2, or provided directly after step S908.

### Variations of the Second Embodiment

If the result of the determination in step S901c is negative, instead of processing returning to step S901c and repeating that step, processing may also return to step S901b. With this variation, if route guidance finishes while downloading is being performed, steps S901e to S901g are executed and the car navigation system 103 can notify that downloading is being performed and that downloading is complete.

The displays in steps S901e and S901g can also be executed by means other than the car navigation system 103. For example, the displays described above can be performed on a head-up display, a speedometer, or the like.

This variation in advantageous in that the aforementioned displays can be used to perform the notifications intended in the steps to the user even if, for example, the user does not use the car navigation system 103. This is because a head-up display, a speedometer, and the like are visible to all users.

In this variation, steps S901b, S901c, and S901d shown in the flowchart in FIG. 7 are omitted.

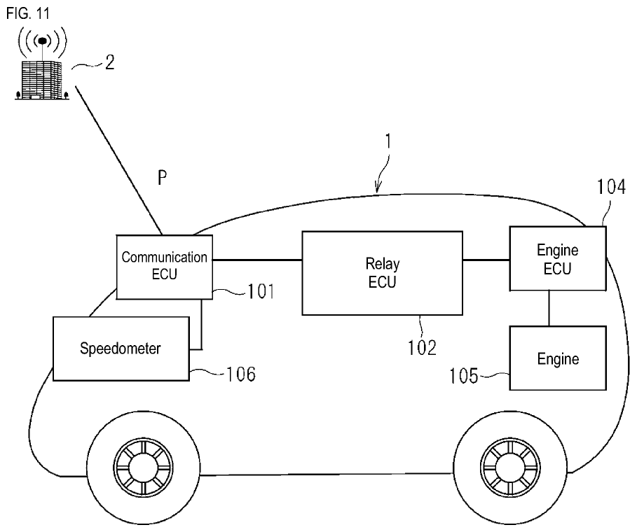

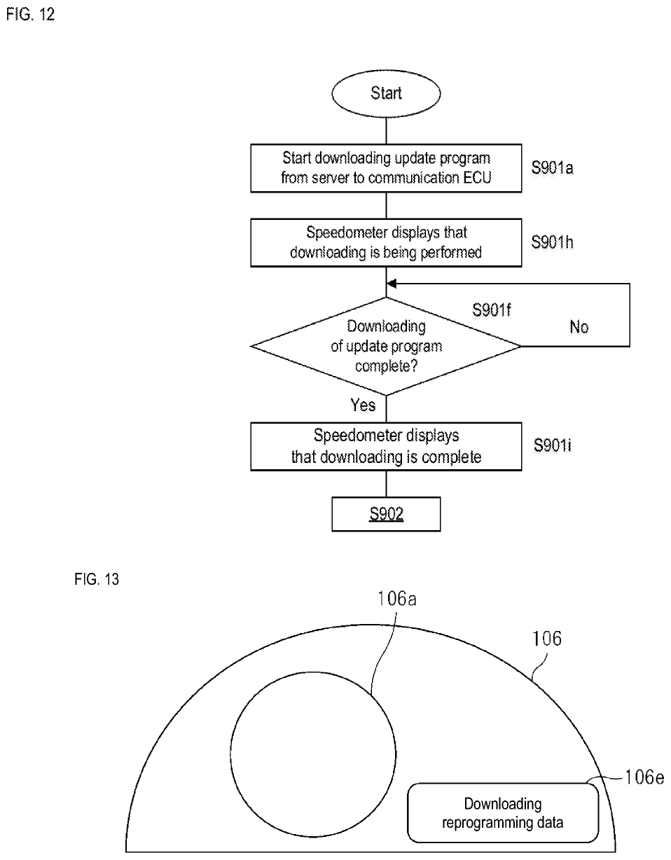

FIG. 11 is a diagram showing the vehicle 1 in which the program updating method according to this variation is performed. FIG. 12 is a flowchart showing the program updating method according to this variation, with some parts omitted. FIGS. 13 to 15 are diagrams showing what is displayed by the speedometer 106 in this variation. FIGS. 11 to 15 correspond to FIGS. 6 to 10, respectively.

The configuration shown in FIG. 11 is a configuration in which the speedometer 106 is installed instead of the car navigation system 103 in the configuration shown in FIG. 6. In this variation, the speedometer 106 is, similarly to the car navigation system 103, also an in-vehicle device that operates under control of the communication ECU 101.

The flowchart shown in FIG. 12 is, similarly to the flowchart shown in FIG. 7, used instead of step S901 in the flowchart shown in FIG. 2. Steps S901h and S901i in this variation correspond respectively to steps S901e and S901g in the second embodiment, and are steps in which “car navigation system” is replaced by the “speedometer”.

In FIGS. 13 to 15, a display 106a is a display that the speedometer 106 usually shows, such as the traveling speed of the vehicle 1, for example. The displays 106e, 106f, and 106g are the same as the displays 103e, 103f, and 103g (FIGS. 8 to 10), respectively.

In this variation, “car navigation system” may also be changed to “speedometer” in steps S905 and S907 (FIG. 2). FIG. 15 corresponds to the case in which “car navigation system” is changed to “speedometer” in step S905.

Needless to say, even if the car navigation system 103 is used, as long as the visibility of route guidance being degraded is not taken as an issue, then displays 103e, 103f, and 103g, similarly to displays 106e, 106f, and 106g, may also be displayed in a similar manner to the flowchart in FIG. 12.

Note that configurations described in the foregoing embodiments and variations can be appropriately combined as long as there are no mutual inconsistencies.

Although the disclosure has been described in detail above, the foregoing description is intended to be illustrative in all respects, and the disclosure is not limited to that description. It should be understood that innumerable variations that are not illustrated herein can be conceived without departing from the scope of the disclosure.

FIG. 1
101 COMMUNICATION ECU
102 RELAY ECU
103 CAR NAVIGATION SYSTEM
104 ENGINE ECU
105 ENGINE

### FIG. 2

[symbol] START
S901 DOWNLOAD UPDATE PROGRAM FROM SERVER TO COMMUNICATION ECU
S902 START TRANSFER OF UPDATE PROGRAM FROM COMMUNICATION ECU TO RELAY ECU
S903 STORAGE OF UPDATE PROGRAM COMPLETE?
S904 TRAVELLING?
S905 CAR NAVIGATION SYSTEM DISPLAYS THAT UPDATE PROGRAM IS AVAILABLE (AND/OR) UPDATING CAN BE PERFORMED
S906 UPDATING INSTRUCTED?
S907 CAR NAVIGATION SYSTEM DISPLAYS THAT UPDATING IS BEING PERFORMED
S908 START UPDATING ENGINE ECU
S909 UPDATING COMPLETE?
S910 ERASE DISPLAY THAT UPDATING IS BEING PERFORMED
S911 ERASE DISPLAY THAT UPDATING IS AVAILABLE (AND/OR) UPDATING CAN BE PERFORMED AND STANDBY FOR
PREDETERMINED TIME
[symbol] END

### FIG. 3

[symbol] MAP

### FIG. 4

[symbol] MAP
103B PERFORM UPDATE?

### FIG. 5

[symbol] MAP
103C UPDATING

### FIG. 6

101 COMMUNICATION ECU
102 RELAY ECU
103 CAR NAVIGATION SYSTEM
104 ENGINE ECU
105 ENGINE

### FIG. 7

[symbol] START
S901A START DOWNLOADING UPDATE PROGRAM FROM SERVER TO COMMUNICATION ECU
S901B NAVIGATION SYSTEM PERFORMING ROUTE GUIDANCE?
S901C DOWNLOADING OF UPDATE PROGRAM COMPLETE?
S901D ROUTE GUIDANCE COMPLETE?
S901E CAR NAVIGATION SYSTEM DISPLAYS THAT DOWNLOADING IS BEING PERFORMED
S901F DOWNLOADING OF UPDATE PROGRAM COMPLETE?
S901G CAR NAVIGATION SYSTEM DISPLAYS THAT DOWNLOADING IS COMPLETE

### FIG. 8

[symbol] MAP
103E DOWNLOADING REPROGRAMMING DATA

### FIG. 9

[symbol] MAP
103F DOWNLOADING OF REPROGRAMMING DATA COMPLETE

### FIG. 10

[symbol] MAP
103G REPROGRAMMING DATAAVAILABLE. PERFORM UPDATE?

### FIG. 11

101 COMMUNICATION ECU
102 RELAY ECU
103 CAR NAVIGATION SYSTEM
104 ENGINE ECU
105 ENGINE
106 SPEEDOMETER

### FIG. 12

[symbol] START
S901A START DOWNLOADING UPDATE PROGRAM FROM SERVER TO COMMUNICATION ECU
S901H SPEEDOMETER DISPLAYS THAT DOWNLOADING IS BEING PERFORMED
S901F DOWNLOADING OF UPDATE PROGRAM COMPLETE?
S901I SPEEDOMETER DISPLAYS THAT DOWNLOADING IS COMPLETE

### FIG. 13

106E DOWNLOADING REPROGRAMMING DATA

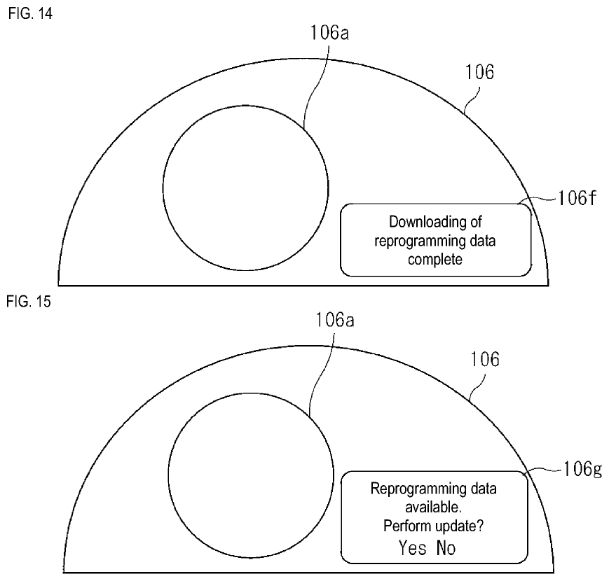

### FIG. 14

106F DOWNLOADING OF REPROGRAMMING DATA COMPLETE

### FIG. 15

106G REPROGRAMMING DATAAVAILABLE. PERFORM UPDATE?

1. A program updating method for updating a program that controls an operation of a device that is installed in a vehicle, the program updating method comprising:
a first step of determining whether or not a storage of an update program for updating the program is complete;
a second step of notifying that the storage is complete when a result of the determination in the first step is affirmative; and
a third step of, after the second step, starting updating of the program by means of the stored update program after a predetermined instruction.

2. The program updating method according to claim 1, wherein
in the second step, it is notified that the storage is complete after it is determined that the vehicle is not traveling.

3. The program updating method according to claim 1, further comprising:
a fourth step of notifying that the updating is continuing, directly before or directly after the third step.

4. The program updating method according to claim 1, further comprising:
a fifth step of notifying that the updating is complete, after the updating is complete.

5. The program updating method according to claim 1, further comprising:
a sixth step of starting downloading of the update program before the first step is executed; and
a seventh step of displaying that the downloading is complete, after the downloading is complete,
wherein the vehicle has further installed a display apparatus that has both a first function of displaying predetermined information and a second function of executing the seventh step,
the seventh step is, when the display apparatus is exhibiting the first function, executed after the first function has stopped even if the downloading is complete after the sixth step, and
the seventh step is, when the display apparatus has stopped the first function, executed after the downloading is complete after the sixth step.

6. The program updating method according to claim 2, further comprising:
a fourth step of notifying that the updating is continuing, directly before or directly after the third step.

7. The program updating method according to claim 2, further comprising:
a fifth step of notifying that the updating is complete, after the updating is complete.

8. The program updating method according to claim 3, further comprising:
a fifth step of notifying that the updating is complete, after the updating is complete.

9. The program updating method according to claim 2, further comprising:
a sixth step of starting downloading of the update program before the first step is executed; and
a seventh step of displaying that the downloading is complete, after the downloading is complete,
wherein the vehicle has further installed a display apparatus that has both a first function of displaying predetermined information and a second function of executing the seventh step,
the seventh step is, when the display apparatus is exhibiting the first function, executed after the first function has stopped even if the downloading is complete after the sixth step, and
the seventh step is, when the display apparatus has stopped the first function, executed after the downloading is complete after the sixth step.

10. The program updating method according to claim 3, further comprising:
a sixth step of starting downloading of the update program before the first step is executed; and
a seventh step of displaying that the downloading is complete, after the downloading is complete,
wherein the vehicle has further installed a display apparatus that has both a first function of displaying predetermined information and a second function of executing the seventh step,
the seventh step is, when the display apparatus is exhibiting the first function, executed after the first function has stopped even if the downloading is complete after the sixth step, and
the seventh step is, when the display apparatus has stopped the first function, executed after the downloading is complete after the sixth step.

11. The program updating method according to claim 4, further comprising:
a sixth step of starting downloading of the update program before the first step is executed; and
a seventh step of displaying that the downloading is complete, after the downloading is complete,
wherein the vehicle has further installed a display apparatus that has both a first function of displaying predetermined information and a second function of executing the seventh step,
the seventh step is, when the display apparatus is exhibiting the first function, executed after the first function has stopped even if the downloading is complete after the sixth step, and
the seventh step is, when the display apparatus has stopped the first function, executed after the downloading is complete after the sixth step.
